(19) United States
(12) Patent Application Publication
(10) Pub. No.: US 2025/0291628 A1
(43) Pub. Date: Sep. 18, 2025

(54) WEB BROWSER DECISION TASK ASSISTANT

(71) Applicant: Microsoft Technology Licensing, LLC, Redmond, WA (US)

(72) Inventors: Kintu BHANDARI, Hyderabad (IN); Amit DANGWAL, Hyderabad (IN); Vinayak PANCHOLI, Hyderabad (IN); Shubham KESHARWANI, Hyderabad (IN); Payal ARORA, Bengaluru (IN); Rajib GHOSH, Hyderabad (IN)

(21) Appl. No.: 18/607,856

(22) Filed: Mar. 18, 2024

(51) Int. Cl. G06F 9/48

(52) U.S. Cl. CPC G06F 9/4881

(57) ABSTRACT

A web browser includes a decision task assistant that parses and analyzes web content of multiple browser tabs concurrently open within a browser session. The decision task assistant creates a decision task tab group that includes the subset of the multiple browser tabs that references webpage subjects pertaining to a common decision task. The decision task assistant discovers attributes of the webpage subjects and displays a decision task summary for the decision task tab group. The decision task summary includes task-specific comparative parameters referencing one or more of the discovered attributes of website subjects in association with content cards summarizing information pertaining to each of the website subjects.

### BACKGROUND

Web browsers are often used to help people compare, evaluate, decide and select between options for various types of life tasks such as researching colleges, comparing products (e.g., best-performing laptops within a set price range), finding the most convenient flights for a trip, selecting vacation accommodations, and more. When researching options for a particular decision task, a user may initially query a web browser for information about a subject of interest, such as a product or, service.

When the user identifies a website(s) of interest during the above-described type of decision task, the user may want to preserve a link to the website(s) to allow the user to easily navigate back to the website(s) in the future to re-review the site content as the user narrows down options and gets closer to making an end decision. To this end, the user has limited tools available. While most web browsers support “bookmarking”, bookmarks can be onerous to manage (e.g., requiring manual creation of project-specific bookmark folders). In common practice, a user is more likely to open all the websites of interest in a separate browser tab and leave the tab open for an extended period while continuing to research other alternative options and/or perform other unrelated web-based tasks. In such scenario, the user may open browser tabs corresponding to various websites that provide alternative options for the same decision task. If, for example, the decision task is booking an accommodation option for an upcoming trip, the user may open different browser tabs corresponding to different hotel booking websites (e.g., Booking.com, Hotels.com) as well as websites for private listings such as rentals available through hosts such as Airbnb.com and vrbo.com).

During the above-described selection process, the user may toggle back and forth between these websites with concurrently open browser tabs by clicking on the browser tabs in the top menu bar as-needed while also performing complicated sequence of steps are that are not necessarily sequential. For example, the user may conduct research to such as gathering requirements for a particular task, search the web for options that satisfy the identified requirements, shortlisting options, narrowing down to two to three options, and making a final decision. This methodology requires users to compare shortlisted options across multiple browser tabs sometimes on multiple parameters, which is difficult, time consuming, and leads to an extremely cluttered tab bar in a browser. In addition, it is also possible that in case the browser closes unexpectedly for some reason (e.g., due to a system or browser restart, or a browser or system crash) all these tabs that the user has kept open for comparison, may be lost.

### SUMMARY

According to one implementation, a web browser parses and analyzes web content of multiple browser tabs of a browser session to identify a subset of the multiple browser tabs referencing webpage subjects pertaining to a common decision task. In response to identifying the subset of the multiple browser tabs, the web browser creates a decision task side pane that includes the information from the subset of multiple related browser tabs and further analyzes the web content displayed within browser tabs of the decision task tab group to discover attributes of the webpage subjects. The web browser generates and displays on the side pane, a decision task summary for the decision task tab group that includes task-specific comparative parameters referencing one or more of the discovered attributes of website subjects in association with content cards summarizing information pertaining to each of the website subjects.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates example aspects of a web browser that generates an interactive summary to assist a user with a decision task within a web browser.

FIG. 2 illustrates example aspects of another web browser that includes a decision task assistant that generates a decision task summary user interface (UI).

FIG. 3 illustrates example operations for generating an interactive summary to assist a user with a decision task within a web browser.

FIG. 4 illustrates an example schematic of a processing device suitable for implementing aspects of the disclosed technology.

### DETAILED DESCRIPTION

The herein disclosed technology includes a decision task assistant that is integrated within a web browser. The decision task assistant approach is created based on the comparative decision model. Comparative decision model is a framework used to make decisions by comparing different options or concepts. This model can also be extended to include probabilistic choice predictions and accommodate psychologically plausible choice models. The decision task assistant parses and analyzes web content of browser tabs open within a browser session to identify groups of tabs featuring web content pertaining to common decision task (e.g., websites that feature subjects characterized by a common subject category). Upon identifying a group of tabs that pertain to a common decision task, the decision task assistant condenses the parsed content into a decision task summary and presents the decision task summary to the user in a user interface that features various interactive tools to help the user to organize, prioritize, filter, add and eliminate options-guiding the user to a final decision all within a single easy-to-use browser panel.

According to one implementation, the decision task assistant presents the user with comparative parameters and/or filter options that differ in form depending upon relevant attributes of the options that the user is considering and/or based on the user's own preferences and inclinations. In some implementations, the decision task assistant utilizes artificial intelligence (AI) to identify attributes of different webpage subjects representing different selection options and to further identify a selection of those attributes that are common to multiple of the different options (e.g., subjects described in different browser tabs). For example, the decision task assistant may determine that the user is considering nine different hotel options for a trip, provide contextual information of the hotels (e.g., website descriptions) to a large language model (LLM) and ask the LLM to receive attributes for those hotels and/or identify attribute common to multiple of the hotels being considered. Because the LLM uses its own body of training data to make these attribute inferences, the attributes identified in this way can be external to the website descriptions. For example, the LLM may determine, based on website hotel address information and map information in the LLM's training dataset, that 7/10 hotels are located on the beach, and present the user with a filter option “Waterfront Properties.”

In still other implementations, the decision task assistant intelligently selects user-personalized filter options to provide to the user within the decision task summary. These user-personalized filter options are, in various implementations, provided based on the user's previous web interactions and/or based on stored profile data for the user. If, for example, a high percentage of hotel reservations that the user previously placed via the web browser were in urban areas and/or walking distance of dining options, entertainment, and other locations of interest, the decision task assistant may provide the user with a filter option “High Walkability Score” to help the user quickly identify a subset of the concurrently open tabs pertaining to the task that are characterized by this user preference.

In one implementation, the decision task assistant presents a decision task summary UI that includes content summary cards corresponding to each different concurrently-open browser tab pertaining to the same decision task. The decision task summary UI includes interactive menu options that allow the user to eliminate options, temporarily hide options, restore previously hidden options, and/or prioritize (e.g., reorder, flag, or otherwise rank) the options. The decision task summary UI is presented alongside (concurrent with) web content of each open browser tab pertaining to the task. In one implementation, the user can interact with (e.g., click on) the different summary cards in the decision task summary UI (e.g., in a panel on the side of the open browser tab) to switch the currently-presented browser tab between different tabs pertaining to the same decision task. In another implementation, the user can selectively “remove” options in the summary tab and, in doing so, close the corresponding browser tabs.

Advantageously, the above-described features of the decision task summary UI allows the user's decision-making interactions with web content to be moved away from multiple tabs that require constant tab switching to view and compare to a different surface—e.g., a sub-window within the open browser tab that displays the decision task summary UI. In contrast to the scattered information across tabs, the decision task summary UI includes user-relevant comparison parameters from the subjects described within the open tabs and these parameters are displayed in an easy-to-interpret and interact-with format.

Still other implementations allow the user to share a given decision task assistant UI with other users that can then collaborate to add options to a given decision task as well as to narrow down and select between the options. In some implementations, the decision task assistant preserves decision task summary information across multiple user browser sessions to allow a user to drop the process and resume at later time.

Advantageously, the decision task assistant aggregates information gathered from different web domains to facilitate product and service comparisons across websites available at different web domains. The decision task assistant facilitates comparisons across a wide range of categories (e.g., selecting a college, selecting a new book to read, selecting a vacation rental) and may organize information with a fine level of granularity by providing different decision task summaries for different “tasks” that are part of a same larger task. If, for example, the user has opened some tabs that include movie reviews, trailers, and/or actor biographies and other tabs that feature movie ticket pricing and/or showtimes for different local theaters, the decision task assistant may generate a first decision task summary UI for “selecting a movie” and a different decision task summary UI for “purchasing movie tickets.” The decision task assistant can also predict based on the users interaction and proactively add options in the existing options set, if desired by the user.

The above-described and other benefits are further explored and exemplified through discussion of the following figures.

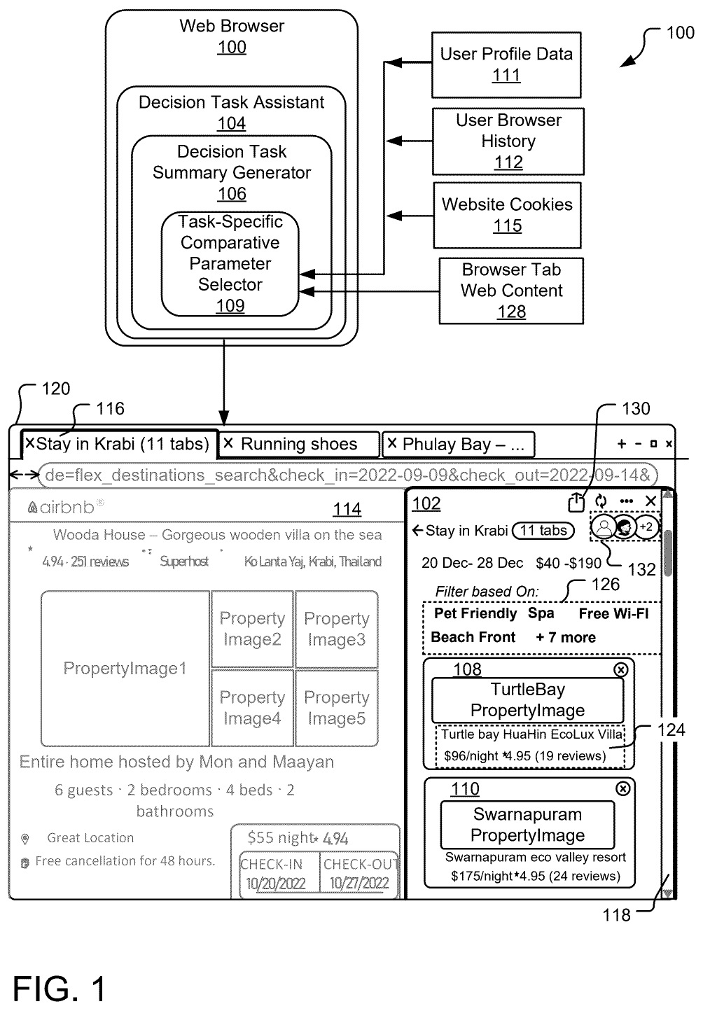

FIG. 1 illustrates example aspects of a web browser 100 that generates an interactive summary, referred to herein as a decision task summary UI 102, to assist a user with a decision task within a web browser 100. The decision task summary UI 102 is generated and presented in a window of the web browser 100 at times when the web browser 100 detects that the user is performing a decision task (e.g., evaluating options that serve a common purpose). The decision task summary UI 102 includes interactive tools that compliment and simplify the user's comparative decision-making process, thereby reducing complexity of the process and the degree to which the user needs to self-organize and access information relevant to the decision making.

Both the web browser 100 and the decision task assistant 104 comprise software stored in memory. The decision task assistant 104 is, in one implementation, a downloadable plugin (also referred to as a browser extension) for the web browser 100. In another implementation, the decision task assistant 104 is a core feature of the web browser 100. In some implementations, the web browser 100 and the decision task assistant 104 both execute on the user device that displays the decision task summary UI 102. In other implementations, aspects of the web browser 100 and/or decision task assistant 104 are performed by different devices. For example, a user device may execute a version of the web browser 100 that communicates with a cloud-based application server, where the cloud-based application server performs some cloud-based processing on behalf of the web browser to reduce the quantity of memory that the use device consumes when executing the web browser.

The decision task assistant 104 is shown to include a decision task summary generator 106, which includes a task-specific attribute selector 109. In general, the decision task summary generator 106 performs operations that provide for generating and presenting the decision task summary UI 102. The task-specific attribute selector 109 selects certain attributes for display within the decision task summary UI 102 based on a case-specific analysis of the options the user is considering (e.g., the primary subject identified with respect to each tab in the decision task tab group 116) and/or based on attributes of the user.

When a user is browsing the web using the web browser 100, the user may open several websites in independent browser tabs. The decision task summary generator 106 implements logic that provides for parsing and analyzing web content of the user's open browser tabs to identify different subsets of the multiple browser tabs that pertain to common decision tasks. This logic is, in different implementations, executed using different rules and enforcement mechanisms.

In one implementation, the decision task summary generator 106 determines that two or more browser tabs pertain to a common decision task when the web content displayed within those browser tabs references subject matter characterized by a common subject category. The decision task summary generator 106 may, for example, analyze website content loaded within different open browser tabs to determine a primary subject (e.g., a product or service) of each tab and/or a corresponding subject category (e.g., a category of products or services) that categorizes the primary subject, such as within a hierarchical knowledge base or other tree-like data structure.

In a rudimentary example of the above, the decision task assistant 104 analyzes a booking website for privately-owned vacation cabin and determines that the website has a primary subject “cabin rental” which is in the subject category “accommodations.” Likewise, the decision task assistant 104 determines that a hotel booking website has a primary subject “hotel reservation,” which is also in the subject category “accommodations.” In this scenario, the decision task assistant 104 determines that the two booking websites pertain to a same decision task because they feature primary subjects of the same subject category.

In the above example, it may be possible for the decision task assistant to determine that the cabin rental website and the hotel booking website are of the common subject category exclusively by analyzing the website uniform resource locators (URLs) (e.g., booking.com is commonly used for hotels and Airbnb.com is used for privately-owned rentals). However, in some implementations of the disclosed technology, the decision task assistant 104 uses website content (e.g., image, text, or audio/video content) that is viewable at a URL to determine the primary subject and subject category associated with the URL (and corresponding browser tab). In one implementation, the decision task assistant 104 parses location information from web content loaded within a browser tab and uses this information to constrain breadth of the subject category. For example, the subject category is “accommodations in Sedona, Arizona” and websites are identified as having primary subjects belonging to this category when they describe accommodation options available in Sedona, Arizona. In still other implementations, the decision task assistant 104 constrains the breadth of the identified “subject category” in other ways, such as based on dates or date ranges associated with the webpage subjects (e.g., one subject category could be “Live Music Events in Chicago the weekend of February 21-22”).

The decision task summary UI 102 may serve to facilitate a variety of types of tasks and is not limited to selections specific to commercially-available products or services. If, for example, the user has open multiple browser tabs that describe different hikes in Kauai, Hawaii (e.g., maps displaying trail information, blogs describing hikes, government websites providing trail information), the decision task assistant 104 may identify the websites as pertaining to the common subject category “Hikes in Kauai” and on this basis determine that these browser tabs pertain to a common decision task. Alternatively, if the user is browsing images of hairstyles to determine how what type of haircut to get, the user may open hairstyle images in different browser tabs and the decision task assistant 104 may identify the websites as pertaining to the common subject category “hairstyles” (e.g., a decision task among various hairstyles).

For each group of open browser tabs identified as pertaining to the same decision task, the decision task assistant 104 creates a corresponding decision task tab group. In one implementation, the decision task assistant 104 modifies menu bar information of the user's web browse to condense browser tabs of the same decision task group under a common browser tab representing the group. For example, in response to recognizing tabs corresponding to a decision task “U.S. College Search”, the decision task assistant creates a new group tab “U.S. College Search” in the menu bar. By clicking on the new group tab, the user can toggle between views that (1) show all tabs in the tab group as separate tabs or (2) condense (hide) the individual tabs within the group so that the group tab is shown and the individual tabs are not.

In some implementations, the decision task assistant 104 automatically create. decision task tab groups. In other implementations, the decision task assistant 104 suggests decision task tab groups to the user and creates each decision task tab group in response to receiving user input confirming that the user wishes to create the group.

In response to creating a new decision task tab group, the decision task summary generator 106 then generates a decision task summary UI (e.g., the decision task summary UI 102) that is specific to the decision task tab group and accessible to the user from within any individual browser tab of the tab group. In the illustrated example, the decision task summary UI 102 is created in association with a decision task tab group 116 entitled “Stay in Krabi.” In this example, all browser tabs in the decision task tab group 116 correspond to URLs that display website content pertaining to activities or lodging in Krabi, Thailand.

In one implementation, the decision task summary UI 102 is accessible to the user from within any of the browser tabs of the decision task tab group 116. For example, toggling between the tabs in the decision task tab group 116 changes the website that is displayed in a primary region 114 of the corresponding open browser window, but does not change the decision task summary UI 102 that is displayed on the panel on the right-hand side of the browser tab window. In various implementation, the decision task summary UI 102 is presented in different locations within the browser tabs. Likewise, the web browser 100 may provide the user with the option to add, hide or restore the decision task summary UI 102 from view.

The decision task summary UI 102 includes content summary cards (e.g., content summary cards 108, 110) that each correspond to a different browser tab within the decision task tab group 116. Each of the content summary cards displays summary information that is extracted from or derived based on content displayed within the corresponding one of the browser tabs in the decision task tab group 116. In the example shown, the content summary card 108 shows a rental listing summary information for a villa in Krabi, Thailand that corresponds to a first browser tab (e.g., of a first domain) in the decision task tab group 116 while the content summary card 110 shows a rental listing for a resort in Krabi, Thailand that corresponds to a different browser tab (e.g., of a second different domain) in the decision task tab group 116. In this example, the decision task tab group 116 includes 11 tabs and the decision task summary UI 102 therefore displays 11 corresponding content summary cards, nine of which are not visible in the illustrated view but which can be seen by scrolling down on scroll bar 118 of the decision task summary UI 102. In some implementations, the decision task summary UI 102 may include browser-recommended options as additional content summary cards.

In one implementation, the web browser 100 toggles the currently-viewed browser tab in response to user interactions with content summary cards 108, 110 of the decision task summary UI 102. For example, when the user clicks on the content summary card 110, the primary region 114 of browser window 120 loads the website corresponding to the content summary card 110. The decision task summary UI 102 remains open and generally unchanged (except to potentially alter a graphical indicator indicating which content summary card is currently selected and displayed in the primary region 114).

The decision task summary UI 102 displays some types of comparative parameters that vary in form depending upon relevant attributes of the options that the user is considering for the decision task and/or based on information that is personalized to the user.” These parameters that may or may not be displayed within a given decision task summary UI are referred to herein as “task-specific comparative parameters” because the selection of such information for presentation in the decision task summary UI 102 depends upon an analysis of attributes of the options the user is considering (e.g., attributes pertaining to browser tab web content 128 for the decision task tab group 116) and/or attributes of the user conducting the associated browsing session including, for example, attributes identified from user profile data 119, user browser history 112 such as search history and click history, and website cookies 115 stored by the web browser 100 that include user-specific information.

In one implementation, the decision task assistant 104 executes logic to identify relevant comparative parameters and to select a subset of the relevant comparative parameters for display that are most likely to be helpful in the user's decision-making process. If, for example, the user is selecting a pair of running shoes, relevant comparative parameters may include shoe features such as stack height, heel-to-toe drop, foam type, support level (neutral, stability, and motion control), or sport type (e.g., trail, track, long-distance, or race-specific). However, depending on the specific running shoe options the user is presently considering and the user's own preferences, some of these comparative parameters may be influential to the user's end decision that others.

In various implementations, the decision task summary UI 102 displays task-specific comparative parameters in different ways such as with content summary cards (e.g., as informative, non-interactive UI elements) and/or as filter options 126 that are presented within the decision task summary UI 102 and each usable to “filter” (e.g., selectively hide and restore) content summary cards characterized by the attribute named by the filtering option.

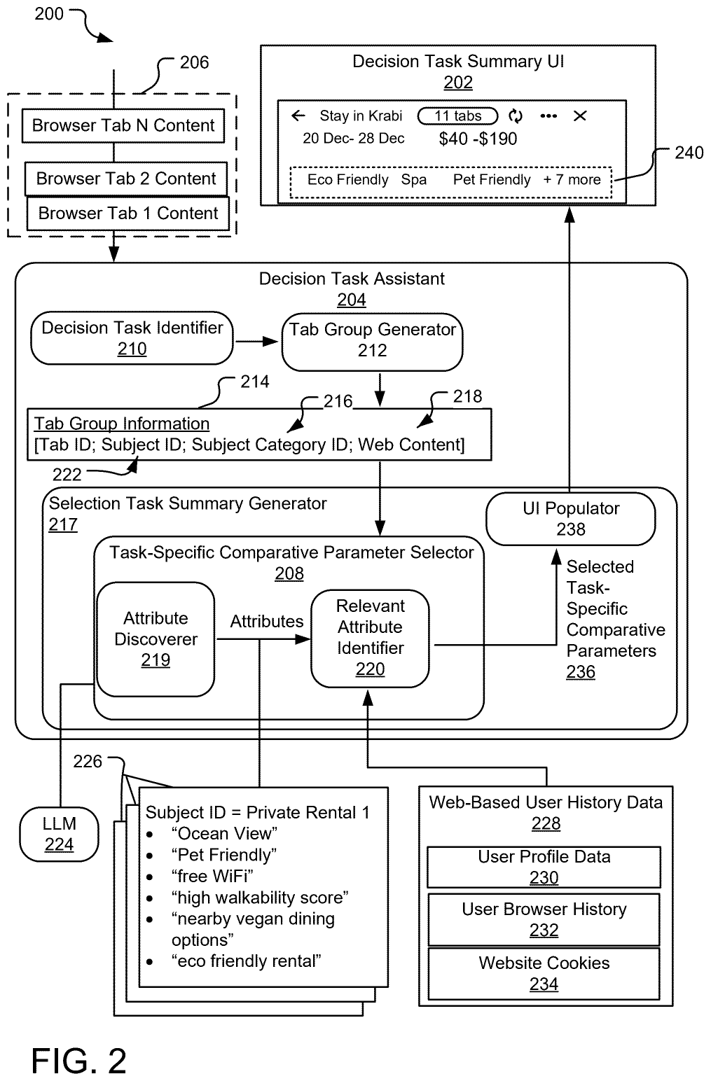

In the example shown, the filter options 126 in the decision task summary UI 102 are intended to represent task-specific comparative parameters that are affirmatively “discovered” with respect to the particular selection tab task group 116 and subsequently elected for selective presentation. Each of the filter options 126 names an option attribute that is has been identified as having specific relevance to the corresponding decision task. A detailed discussion of comparative parameter identification and selection is discussed with respect to FIG. 2. However, by brief example, it may be that one of the filter options 126 is selected because a high percentage of the “options” (browser tabs) being considered are characterized by the comparative parameter. For example, “Beachfront” may be selected as one of the filter options 126 in response to a browser-performed determination that multiple accommodations being considered for the decision task “Stay in Krabi” are characterized by this attribute. In other implementations, one or more of the filter options 126 or other types of comparative parameters are selected based on user-specific preferences, such as preferences determined from the user profile data 111, the user browser history 112, or the stored website cookies 115. For example, it may be that “pet friendly” is selected as one of the filter options 126 in response to a browser-performed determination that the user has a history of booking pet friendly rentals. In some implementations, the filter options can also dynamically change during the course of the users' decision-making journey based on the user action and also on the specific decision task.

In the example of FIG. 1, the summary information 124 is generic (including reviews, pricing information, and listing name) and is not, in this specific example, inclusive of task-specific comparative parameters discovered with respect to the particular decision task tab group 116. However, this summary information 124 can, in other implementations, include task-specific comparative parameters that are discovered and elected for selective presentation in the same manner as that described above with respect to the filter options 126. For example, the content summary cards 108, 110 may display attribute(s) of the corresponding selection option (e.g., the accommodation option) that have been identified as having specific relevance to the corresponding decision task based on the same or similar criteria as that described above with respect to the filter options 126.

In the implementation of FIG. 1, the decision task summary UI 102 includes a sharing icon 130 that, when selected, allows a first user to selectively share the decision task summary UI 102 with additional users who are, upon acceptance, able to use the interactive tools of the decision task summary UI 102 to collaborate on the decision task with the first user. This feature is advantageous when the decision task pertains to a venture to be jointly experienced the collaborators. For example, three college students traveling abroad for spring break may want to be able to share lodging options they are mutual finding and/or allow each other to help eliminate options for their own respective computers. Upon selection of the sharing icon 130, a first user is presented with a prompt requesting web-based account identifiers (e.g., email addresses or messaging account identifiers) for the collaborators and/or the first user is provided with a sharable collaboration link (URL) that can be shared with a user to provide the user with viewing and editing access to the decision task summary UI 102. In response to being selected as a collaborator, a second user receives an invitation to collaborate on the decision task summary UI 102 and a duplicate version of all the tabs pertaining to the decisions task is created in their browser window along with the decision task summary UI 102.

In FIG. 1, collaborator icons 132 indicate which user are collaborators currently have view and edit access to the decision task summary UI 102. In one implementation, collaborators of the decision task summary UI can add options to the decision task summary 102 such as by dragging, right-clicking on a browser tab and selecting a menu option to add the browser tab to the decision task summary, or other suitable action. Likewise, the collaborators can utilize the filter options 126 to hide select content summary cards from view, as well as optionally eliminate content summary cards in the decision task summary UI 102, such as by clicking an “X” in the top-right corner of each card, which has the effect of closing the corresponding browser tab.

In some implementations, decision task summary UI 102 is preserved over multiple web sessions of the user until the decision task summary UI 102 is either manually closed (deleted) by the user or until the web browser detects a user web interaction indicating completion of the decision task. If, for example, the content summary cards 108, 110 display lodging options and the user completes a booking reservation at by interacting with the webpage associated with one of the content summary cards 108, 110, the web browser 100 may automatically determine that the decision task has been completed and, in response, delete the decision task tab group and remove the decision task summary UI from the user display. In another implementation, the web browser 100 prompts the user with a request to close the decision task tab group when the user has not completed the decision task within a threshold period (e.g., “it has been 25 days since you last viewed the tab group “Stay in Krabi.” Would you like to close this tab group?”). In one implementation, the web browser stores the information related to all existing and ongoing decision tasks for a particular user associated with that user's account on the server and can be invoked when logged in on any device using the same web browser and same user account.

FIG. 2 illustrates example aspects of another web browser 200 that includes a decision task assistant 204 that generates a decision task summary UI 202 (a subset of which is shown in FIG. 2). The decision task assistant 204 may be understood as providing the same general functionality as that described with respect to FIG. 1. However, FIG. 2 illustrates certain example sub-components within the decision task assistant 204 that are not described with respect to FIG. 1, and the corresponding discussion of these subcomponents is focused on how the decision task assistant 204 identifies and selects task-specific comparative parameters for inclusion the decision task summary UI 202.

When a user is browsing the web, the user may currently open multiple different browser tabs 206 that feature diverse website content served by the same or different domains. The decision task assistant 204 includes a decision task identifier 210 that parses and analyzes the web content loaded with respect to the different browser tabs 206 to determine which, if any, of the concurrently-open browser tabs pertain to a common decision task. The logic enforced by the decision task identifier 210 may be the same or similar to that discussed in FIG. 1 with respect to the identification of browser tabs pertaining to common decision tasks. In one implementation, the decision task identifier 210 identifies, from the parsed web content, a primary subject that is described by the web content loaded within each of the different browser tabs 206. When two or more browser tabs feature a primary subject of a common subject category, the decision task identifier 210 determines that the browser tabs pertain to a common decision task.

When the decision task identifier 210 identifies a subset of the different browser tabs 206 that pertain to a common decision task, identifiers for those tabs are provided to a tab group generator 212 that creates a decision task tab group pertaining to the decision task. In one implementation, the decision task identifier 210 provides the tab group generator 212 with a tab group information 214 that includes a category identifier 216 that identifies the common subject category characterize a primary subject described by each tab in the decision task tab group. The tab group generator 212 uses this category identifier 216 to name the decision task tab group (e.g., as demonstrated with respect to various examples shown in FIG. 1).

The tab group information 214 is next provided to a decision task summary generator 217 and used as an initial basis for generating the decision task summary UI 202 for the decision task tab group, In the example shown, the tab group information 214 includes information a tab identifier (e.g., the URL loaded within each tab), a subject identifier 222 that identifies a primary subject of each browser tab (e.g., rental name, product name, service name, or other option identifier), the subject category identifier 216, and web content 218 that is loaded within each of the browser tabs of the decision task tab group.

The decision task summary generator 217 parses the web content 218 and, in some implementations, extracts certain predefined comparative summary information (preselected, static data type), such as images, subject/title information, and/or other information. A UI populator 238 begins populating the decision task summary UI 202 with this information.

A task-specific comparative parameter selector 208 selects task-specific comparative parameters for inclusion in the decision task summary UI 202. The task-specific comparative parameter selector 208 includes an attribute discoverer 219 and a relevant attribute identifier 220. The attribute discoverer 219 identifies comparative parameters applicable to the subject matter of different browser tabs in the decision task tab group while the relevant attribute identifier 220 evaluates task-specific relevance of the discovered attributes (e.g., the relevance of the attributes in the context of all options being considered for the decision task and/or the identity of the user) to select a subset of the discovered attributes to be used as task-specific comparative parameters (e.g., filter options 240) presented within decision task summary UI 202.

In some implementations, the attribute discoverer 219 analyzes the web content 218 displayed within browser tabs of the decision task tab group to discover attributes of webpage subjects that pertain to the common decision task. If, for example, the subject identifier 222 for a webpage loaded in a browser tab identifies a hotel, the attribute discoverer 219 may begin its analysis by parsing through the web content 218 of the webpage to extract attributes of the hotel. For example, the webpage may include hotel attributes such as address information, amenities, a pet policy for the hotel, parking information, accessibility features, and more.

In some implementations, the attribute discoverer 219 identifies attributes based on data source(s) external to the webpages loaded in the browser tabs of the decision task tab group. For example, the attribute discoverer 219 parses content of other websites that reference the same primary subject as a given website or utilizes a large language model (LLM) 224 to infer applicable attributes for the primary subject of the website. The LLM is trained to process and respond to natural language queries. The LLM model is, for example, a publicly-available third-party model that processes natural language inputs in a sequential manner to generate corresponding textual outputs. Examples of LLMs include transformer-based models (e.g., a generative pre-trained transformer (GPT) model, an Open Pretrained Transformer (OPT) model, or Bioscience Large Open-science Open-access Multilingual (BLOOM) model), as well as seq2seq models, long short-term memory networks (LSTM), and recurrent neural networks (RNNs).

Notably, an LLM is capable making inferences based on a vast corpus of data sources used to train the LLM, which may for example include web-scraped material such as user reviews, blog posts, news articles translated from a variety of language, weather data, books, and much more. Given the web content 218 for a particular website, the LLM 224 can make intelligent interferences about a subject refenced in the web content that is not evident from the web content alone. For example, the LLM 224 may be able to infer that a hotel referenced by the booking website has received accolades for being eco-friendly (even if not mentioned on the booking website), that bloggers have described a town the hotel is in as having highly-ranked vegan dining options (even if they are offered not at the hotel itself), infer a probable weather forecast at the hotel given a user date range indicated within the web content, and much more.

In one implementation, the attribute discoverer 219 generates an LLM prompt that identifies webpage subjects (e.g., the subject identifier 222 and/or web content 218) for each of the browser tabs in the decision task tab group. The prompt further includes an instruction asking the LLM 224 to identify and return attributes of the various webpage subjects. Using this information and the body of inferential knowledge available within the LLM's training corpus, the LLM 224 is capable of identifying attributes for the webpage subjects that are not referenced within the web content 218. By example, FIG. 2 illustrates discovered attributes 226 for a subject identifier “Private Rental 1”, which corresponds to one of the browser tabs in the decision task tab group. In the illustrated example, the attributes 226 includes include Ocean View, Pet Friendly, free Wi-Fi, High Walkability Score, Nearby Vegan Dining Options, and Eco-Friendly Rental. In real-world implementations, the discovered attributes 226 for a given webpage subject may include tens or hundreds, of attributes. A similar listing of attributes may be retrieved with respect to each option the user is considering (e.g., the primary subject of each different one of the browser tabs).

Following attribute discovery, the relevant attribute identifier 220 conducts a relevancy analysis to identify a most relevant subset of the discovered attributes 226 to feature as comparative parameters within the decision task summary UI 202. In one implementation, the relevancy analysis includes identifying commonalities among the attributes 226 discovered for the different webpage subjects (e.g., common attributes among the different options being considered for the decision task). The relevant attribute identifier 220 identifies a particular one of the attributes 226 as “more relevant” when the attribute characterizes some, but fewer than all, of the webpage subjects corresponding to the different browser tabs. Per this logic, an attribute characterizing 6 of 10 of the options being considered is more relevant than an attribute characterizing all of the options being considered due to the fact that the attribute characterizing the 6 options can be used as a differential basis for potentially eliminating the other four.

In another implementation, the LLM 224 is tasked with identifying commonalities among the attributes 226 discovered for the different webpage subjects. For example, the LLM 224 is prompted with an instruction to identify and return attributes shared by a multiple (and fewer than all) of the various webpage subjects. In some implementations, the LLM 224 is asked to rank the discovered attributes 226 by percentage of commonality across the different webpage subjects.

In some implementations, identifying the most “relevant” of the discovered attributes 226 entails an analysis of web-based user history data 228 to identify a selection of the discovered attributes 226 that are most likely to be of interest (and therefore provide a meaningful comparative basis) to the user conducting the decision task.

In some implementations, the web-based user history data 228 includes user profile data 230 such as information that has been scraped from one or more online social media profiles of the user. If, for example, the user has listed “Japanese culture” as an interest in their social media profile and has posted on social media sites about traveling to Japan or wanting to learn Japanese, the relevant attribute identifier 220 may rank or weight any of the discovered attributes 226 pertaining to Japanese culture more highly (indicating greater relevance) than other discovered attributes. If, for example, the decision task pertains to college selection and the task-specific comparative parameter selector 208 has determined that 3 out of 5 colleges the user is searching have highly-ranked Japanese language programs, the relevant attribute identifier 220 may rank the “highly-ranked Japanese language program” attribute as being more relevant to the college decision task than other discovered attributes of the colleges due to its close affiliation with user interests evidenced by the user profile data 230.

In some implementations, the web-based user history data 228 includes user browser history such as past web searches and web interactions including click data history (e.g., what the user has clicked on and when/frequency), viewing history data (e.g., what the user has viewed and for how long), past purchases, past uploads, downloads, and more. If, for example, the user has previously used the web browser to make reservations at a significant number of pet-friendly hotels, the relevant attribute identifier 220 may weight or rank the “pet friendly” attribute as being more relevant to the hotel decision task than other discovered hotel attributes. Likewise, past click interactions with the browser and with the design task assistant, viewing history, downloads, and uploads can also indicate user interests that be compared to discovered attributes to predict how likely a user is to care about a given attribute.

Similar to the above, the user's web browser may also store website cookies 234 that the relevant attribute identifier 220 uses to select the relevant attributes from the discovered attributes 226. If, for example, the user has made a wish list on a particular website, the user's web browser may store a website cookie that includes the wish list and such information can be accessed to assess likely relevance of a particular attribute to the user.

In some implementations, the relevant attribute identifier 220 constructs an LLM prompt that includes the discovered attributes 226 and aspects of the web-based user history data 228, along with an instruction asking the LLM to utilize the web-based history data to rank the discovered attributes 226 in terms of likely relevance to the user.

In still other implementations, identifying the applicable attributes and relevant attributes is done via a single query to the LLM 224. The task-specific comparative parameter selector 208 constructs an LLM prompt that includes the web-based user history data 228 for the user, the webpage subjects (e.g., the subject identifier 222) associated with each of the browser tabs in the decision task tab group, and/or the web content 218. The LLM prompt additionally includes an instruction asking the LLM 224 to identify attributes of the webpage subjects that are most similar (aka relevant) to the web-based user history data 228. In this scenario, the LLM 224 uses its training corpus to identify correlations between information items included in the web-based user history data 228 and the webpage subjects and/or web content 218. This analysis may lead to identification of user-relevant attributes of the webpage subjects that that are not described within the web content 218 of the browser tabs corresponding to those web subjects. If, for example the web-based user history data 228 reflects recent purchases for gluten-free cookbooks and searches for gluten-free recipes, the LLM 224 may, if trained on review history for restaurants across the country, be able to identify a particular hotel the user is considering as being characterized by an attribute “nearby gluten-free dining”, which has a high likelihood of being relevant to the user.

Per any of the methodologies described above that assess attribute relevance using web-based user history data 228, the task-specific comparative parameter selector 208 identifies and selects “relevant attributes” from the discovered (applicable) attributes based on determined similarity (e.g., commonalities) between those attributes and the user's web history data. For example, the relevant attribute are descriptive of web-based subject matter that the user has previously interacted with or descriptive of subjects referenced within the user's own web-based profile information.

After selecting the relevant attributes per any of the above-described methodologies, the relevant attribute identifier 220 outputs the relevant attributes as selected task-specific comparative parameters 236. A UI populator 238 then selectively populates the decision task summary UI 202 using the selected task-specific comparative parameters 236. For example, the decision task summary UI 202 illustrates filter options 240 that correspond to a subset of the discovered attributes 226 identified as most relevant to the user's selection.

Other functions of the web browser 200 not specifically described with respect to FIG. 2 may be the same or similar to those described with respect to FIG. 1.

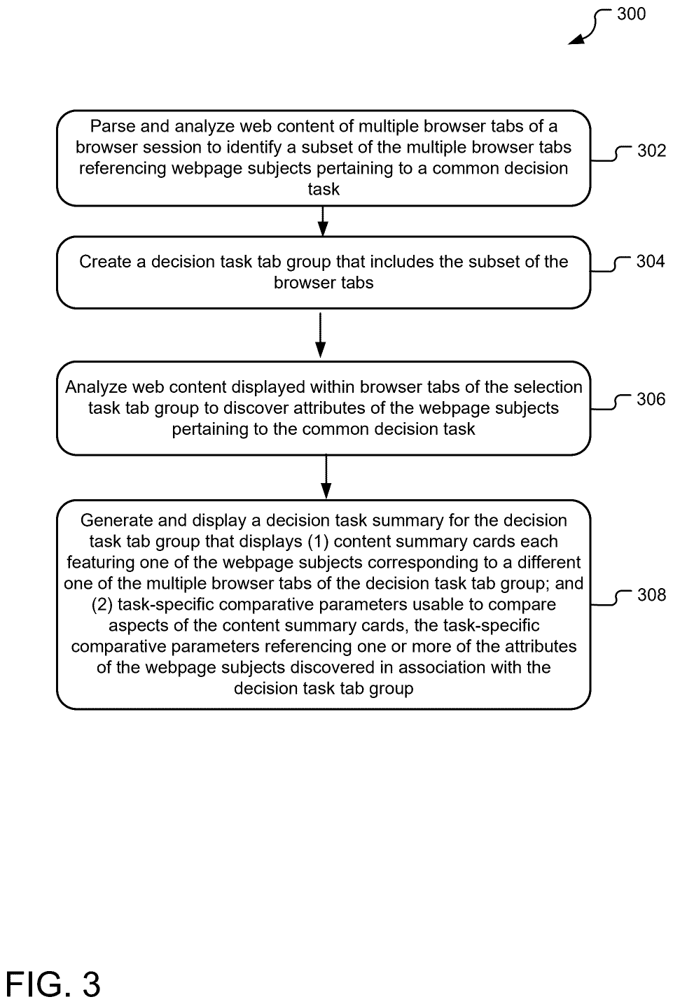

FIG. 3 illustrates example operations 300 for generating an interactive summary to assist a user with a decision task within a web browser. A parsing and analyzing operation 302 parses and analyzes web content of multiple browser tabs concurrently open with in browser session and, based on the parsing and analysis, identifies a subset of the multiple browser tabs that reference webpage subjects pertaining to a common decision task. In one implementation, the parsing and analyzing operation 302 includes identifying a primary subject referenced within each of the multiple browser tabs and determining that a subset of the browser tabs pertain to a common decision task when the associated primary subjects belong to a common subject category.

A group creation operation 304 creates a decision task tab group that includes the subset of the browser tabs pertaining to the common decision task and an attribute discovery operation 306 analyzes web content displayed within the browser tabs of the decision task tab group to discover attributes of the webpage subjects pertaining to the common decision task. In some implementations, the attribute discovery operation 306 includes prompting an LLM to discover attributes of the webpage subjects, such as based on the web content of the associated browser tabs and the body of inferential knowledge made available via the LLM's training dataset. In some implementations, the attribute discovery operation 306 further includes a step of identifying and selecting relevant attributes from among the discovered attributes. For example, relevant attributes may include attributes that pertain to multiple of and fewer than all of the browser tabs within the decision task tab group. In some implementations, attributes of the webpage subjects are selected as relevant for also characterizing aspects of a user's web history (e.g., items that a user has previously interacted with or searched for) and/or that characterize features stored within a web-based profile of the user.

The operations 300 further includes a decision task summary generation and display operation that generates and displays a decision task summary for the decision task tab group on a display of a user device. The decision task summary includes: (1) content summary cards that each feature one of the webpage subjects corresponding to a different one of the multiple browser tabs of the decision task tab group and (2) task-specific comparative parameters usable to compare aspects of the content summary cards. The task-specific comparative parameters reference one or more of the attributes of the webpage subjects discovered in association with the decision task tab group. In one implementation, the task-specific comparative parameters include attributes identified as being “most relevant” to the decision task, such as based on the specific options the user is considering for fulfillment of the decision task and/or attributes of the user (e.g., as evidenced by the user's web history data or web-based profile information). In some implementations, the task-specific comparative parameters are non-interactive UI elements presented within the content summary cards of the decision task summary. In other implementations, the task-specific comparative parameters are interactive UI elements, such as filter options that the user can select to hide and restore information (e.g., select content summary cards) displayed within the decision task summary.

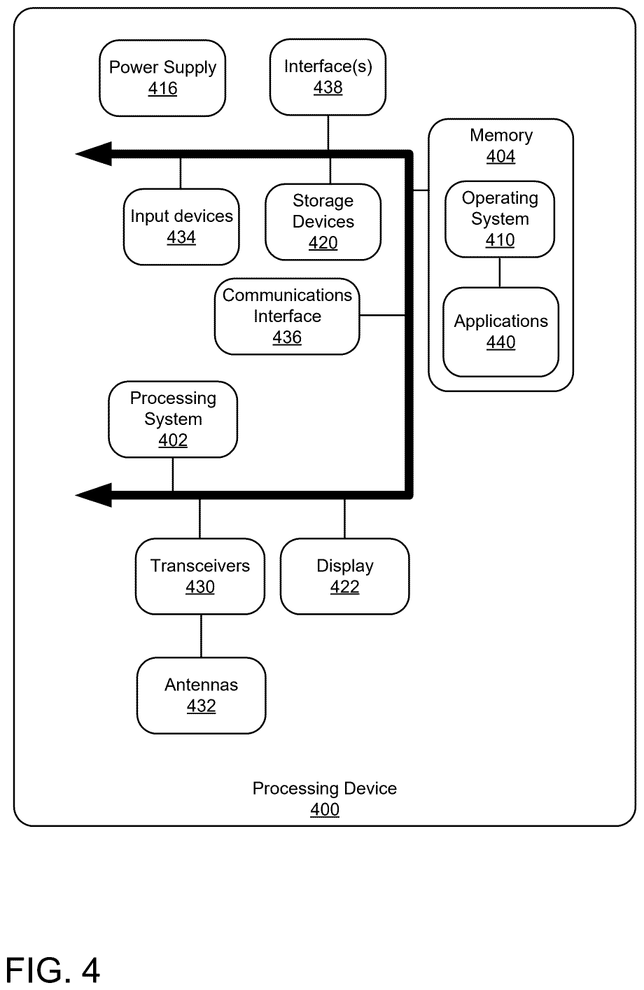

FIG. 4 illustrates an example schematic of a processing device 400 suitable for implementing aspects of the disclosed technology. The processing device 400 includes a processing system 402, memory 404, a display 422, and other interfaces 438 (e.g., buttons). The processing system 402 may each include one or more computer processing units (CPUs), graphics processing units (GPUs), etc.

The memory 404 generally includes both volatile memory (e.g., random access memory (RAM)) and non-volatile memory (e.g., flash memory). An operating system 410, such as the Microsoft Windows® operating system, the Microsoft Windows® Phone operating system or a specific operating system designed for a gaming device, may reside in the memory 404 and be executed by the processing system 402, although it should be understood that other operating systems may be employed.

One or more applications 440 (e.g., the web browser 100 and decision task assistant 104) are loaded in the memory 404 and executed on the operating system 410 by the processing system 402. In some implementations, aspects of the decision task assistant 104 are loaded into memory of different processing devices connected across a network. The applications 440 may receive inputs from one another as well as from various input local devices 434 such as a microphone, input accessory (e.g., keypad, mouse, stylus, touchpad, gamepad, racing wheel, joystick), or a camera.

Additionally, the applications 440 may receive input from one or more remote devices, such as remotely-located servers or smart devices, by communicating with such devices over a wired or wireless network using more communication transceivers 430 and an antenna 432 to provide network connectivity (e.g., a mobile phone network, Wi-Fi®, Bluetooth®). The processing device 400 may also include one or more storage devices 420 (e.g., non-volatile storage). Other configurations may also be employed. In one implementation, the decision task assistant 104 is an application executing on the processing device 400 or as a distributed application with different components executing on many different devices.

The processing device 400 further includes a power supply 416, which is powered by one or more batteries or other power sources and which provides power to other components of the processing device 400. The power supply 416 may also be connected to an external power source (not shown) that overrides or recharges the built-in batteries or other power sources.

The processing device 400 may include a variety of tangible computer-readable storage media and intangible computer-readable communication signals. Tangible computer-readable storage can be embodied by any available media that can be accessed by the processing device 400 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes RAM, read-only memory (ROM), electrically erasable programmable read-only memory (EEPROM), flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 400. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, radio frequency (RF), infrared and other wireless media.

In some aspects, the techniques described herein relate to a system including: a web browser stored in memory and configured to: parse and analyze web content of multiple browser tabs of a browser session to identify a subset of the multiple browser tabs referencing webpage subjects pertaining to a common decision task; create a decision task tab group that includes the subset of the multiple browser tabs; analyze web content displayed within browser tabs of the decision task tab group to discover attributes of the webpage subjects pertaining to the common decision task; generate and display a decision task summary for the decision task tab group, the decision task summary including: content summary cards each featuring one of the webpage subjects corresponding to a different one of the multiple browser tabs of the decision task tab group; task-specific comparative parameters usable to compare aspects of the content summary cards, the task-specific comparative parameters referencing one or more of the attributes of the webpage subjects discovered in association with the decision task tab group.

In some aspects, the techniques described herein relate to a system, wherein the task-specific comparative parameters are parameters that change from one decision task to another and that are selected based on commonalities of the webpage subjects being considered for fulfillment of the common decision task or based on characteristics of a user of the browser session.

In some aspects, the techniques described herein relate to a system, wherein the task-specific comparative parameters include filter options that each reference a given attribute of the attributes discovered, the filter options being selectable by a user to hide or unhide a subset of the content summary cards featuring a subset of the webpage subjects characterized by the filter options.

In some aspects, the techniques described herein relate to a system, wherein identifying the attributes of the webpage subjects further includes: transmitting a request to a large language model (LLM), the request identifying the webpage subjects and prompting the LLM to return attributes shared by multiple of the webpage subjects.

In some aspects, the techniques described herein relate to a system, wherein the web browser is further adapted to: select a subset of attributes returned by the LLM to feature as the task-specific comparative parameters, each attribute in the subset being either: descriptive of a subject referenced by a webpage that a user of the browser session previously interacted with; or descriptive of a subject referenced in web-based profile information stored for the user.

In some aspects, the techniques described herein relate to a system, wherein the task-specific comparative parameters are personalized to a user based on previous web interactions of the user or based on stored profile data for the user.

In some aspects, the techniques described herein relate to a system, wherein the task-specific comparative parameters identify an attribute characterizing a subject of a past web interaction of a user.

In some aspects, the techniques described herein relate to a system, wherein the task-specific comparative parameters identify an attribute characterizing a subject referenced within profile data stored by the web browser for a user.

In some aspects, the techniques described herein relate to a system, wherein the decision task summary includes a UI tool that allows sharing of the decision task summary and collaboration by multiple users.

In some aspects, the techniques described herein relate to a system, wherein the web browser is further configured to: detect a user web interaction indicating completion of a task associated with the decision task tab group; and in response to detection of the user web interaction, automatically delete the decision task tab group and the decision task summary.

In some aspects, the techniques described herein relate to a method for generating an interactive summary to assist a user with a decision task within a web browser, the method including: parsing and analyzing web content of multiple browser tabs of a browser session to identify a subset of the multiple browser tabs referencing webpage subjects pertaining to a common decision task; creating, by the web browser, a decision task tab group that includes the subset of the multiple browser tabs; analyzing web content displayed within browser tabs of the decision task tab group to discover attributes of the webpage subjects pertaining to the common decision task; generating and displaying a decision task summary for the decision task tab group, the decision task summary including: content summary cards each featuring one of the webpage subjects corresponding to a different one of the multiple browser tabs of the decision task tab group; and task-specific comparative parameters usable to compare aspects of the content summary cards, the task-specific comparative parameters referencing one or more of the attributes of the webpage subjects discovered in association with the decision task tab group.

In some aspects, the techniques described herein relate to a method, wherein the task-specific comparative parameters are parameters that change from one decision task to another and that are selected based on commonalities of the webpage subjects being considered for fulfillment of the common decision task or based on characteristics of the user conducting the common decision task.

In some aspects, the techniques described herein relate to a method, wherein the task-specific comparative parameters include at least one of: filter options that each reference a given attribute of the webpage subjects referenced by the multiple browser tabs, the filter options being selectable by a user to hide or unhide a subset of the content summary cards that feature webpage subjects characterized by the corresponding attributes; or attributes displayed within the content summary cards.

In some aspects, the techniques described herein relate to a method, wherein identifying the attributes of the webpage subjects further includes: transmitting a request to a large language model (LLM), the request identifying the webpage subjects and prompting the LLM to return attributes shared by multiple of the webpage subjects.

In some aspects, the techniques described herein relate to a method, wherein the web browser is further adapted to: select a subset of attributes returned by the LLM to feature as the task-specific comparative parameters, each attribute in the subset being selected based on similarity to an item referenced within web-based user history data of the user.

In some aspects, the techniques described herein relate to a method, wherein the task-specific comparative parameters are personalized to a user based on previous web interactions and interactions with the decision task assistant of the user or based on stored profile data for the user.

In some aspects, the techniques described herein relate to a method, wherein the task-specific comparative parameters identify at least one of: an attribute characterizing a subject of a past web interaction of the user; or a subject referenced within profile data stored by the web browser for the user.

In some aspects, the techniques described herein relate to 8The method, further including: in response to user selection of a sharing icon presented by the web browser in association with the decision task summary, making the decision task summary available for viewing and editing by one or more additional users interacting with a different instance of the web browser.

In some aspects, the techniques described herein relate to one or more tangible computer-readable storage media encoding computer-executable instructions for executing a computer process, the computer process including: parsing and analyzing web content of multiple browser tabs of a browser session to identify a subset of the multiple browser tabs referencing webpage subjects pertaining to a common decision task; creating a decision task tab group that includes the subset of the multiple browser tabs; generating and displaying a decision task summary for the decision task tab group, the decision task summary including: content summary cards each featuring a summary of content displayed by a different one of the multiple browser tabs of the decision task tab group; and filter options personalized to at least one of the common decision task or a user of the browser session, each of the filter options referencing a discovered attribute of the webpage subjects referenced by the web content of one of the multiple browser tabs, the filter options each being selectable by a user to hide or unhide a subset of the content summary cards featuring a subset of the webpage subjects characterized by the filter options.

In some aspects, the techniques described herein relate to one or more tangible computer-readable storage media, wherein generating and displaying the decision task summary further includes: transmitting a request to a large language model (LLM), the request identifying the webpage subjects and a request asking the LLM to discover and return attributes of the webpage subjects; and selecting a subset of attributes returned by the LLM to feature as the filter options, each attribute in the subset being either selected based on similarity to previous web interactions of the user or similarity to stored profile data for the user.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A system comprising:
a web browser stored in memory and configured to:
parse and analyze web content of multiple browser tabs of a browser session to identify a subset of the multiple browser tabs referencing webpage subjects pertaining to a common decision task;
create a decision task tab group that includes the subset of the multiple browser tabs;
analyze web content displayed within browser tabs of the decision task tab group to discover attributes of the webpage subjects pertaining to the common decision task;
generate and display a decision task summary for the decision task tab group, the decision task summary including:
content summary cards each featuring one of the webpage subjects corresponding to a different one of the multiple browser tabs of the decision task tab group;
task-specific comparative parameters usable to compare aspects of the content summary cards, the task-specific comparative parameters referencing one or more of the attributes of the webpage subjects discovered in association with the decision task tab group.

2. The system of claim 1, wherein the task-specific comparative parameters are parameters that change from one decision task to another and that are selected based on commonalities of the webpage subjects being considered for fulfillment of the common decision task or based on characteristics of a user of the browser session.

3. The system of claim 1, wherein the task-specific comparative parameters include filter options that each reference a given attribute of the attributes discovered, the filter options being selectable by a user to hide or unhide a subset of the content summary cards featuring a subset of the webpage subjects characterized by the filter options.

4. The system of claim 1, wherein identifying the attributes of the webpage subjects further comprises:
transmitting a request to a large language model (LLM), the request identifying the webpage subjects and prompting the LLM to return attributes shared by multiple of the webpage subjects.

5. The system of claim 4, wherein the web browser is further adapted to:
select a subset of attributes returned by the LLM to feature as the task-specific comparative parameters, each attribute in the subset being either:
descriptive of a subject referenced by a webpage that a user of the browser session previously interacted with; or
descriptive of a subject referenced in web-based profile information stored for the user.

6. The system of claim 1, wherein the task-specific comparative parameters are personalized to a user based on previous web interactions of the user or based on stored profile data for the user.

7. The system of claim 1, wherein the task-specific comparative parameters identify an attribute characterizing a subject of a past web interaction of a user.

8. The system of claim 1, wherein the task-specific comparative parameters identify an attribute characterizing a subject referenced within profile data stored by the web browser for a user.

9. The system of claim 1, wherein the decision task summary includes a UI tool that allows sharing of the decision task summary and collaboration by multiple users.

10. The system of claim 1, wherein the web browser is further configured to:
detect a user web interaction indicating completion of a task associated with the decision task tab group; and
in response to detection of the user web interaction, automatically delete the decision task tab group and the decision task summary.

11. A method for generating an interactive summary to assist a user with a decision task within a web browser, the method comprising:
parsing and analyzing web content of multiple browser tabs of a browser session to identify a subset of the multiple browser tabs referencing webpage subjects pertaining to a common decision task;
creating, by the web browser, a decision task tab group that includes the subset of the multiple browser tabs;
analyzing web content displayed within browser tabs of the decision task tab group to discover attributes of the webpage subjects pertaining to the common decision task;
generating and displaying a decision task summary for the decision task tab group, the decision task summary including:
content summary cards each featuring one of the webpage subjects corresponding to a different one of the multiple browser tabs of the decision task tab group; and
task-specific comparative parameters usable to compare aspects of the content summary cards, the task-specific comparative parameters referencing one or more of the attributes of the webpage subjects discovered in association with the decision task tab group.

12. The method of claim 11, wherein the task-specific comparative parameters are parameters that change from one decision task to another and that are selected based on commonalities of the webpage subjects being considered for fulfillment of the common decision task or based on characteristics of the user conducting the common decision task.

13. The method of claim 11, wherein the task-specific comparative parameters include at least one of:
filter options that each reference a given attribute of the webpage subjects referenced by the multiple browser tabs, the filter options being selectable by a user to hide or unhide a subset of the content summary cards that feature webpage subjects characterized by the corresponding attributes; or
attributes displayed within the content summary cards.

14. The method of claim 11, wherein identifying the attributes of the webpage subjects further comprises:
transmitting a request to a large language model (LLM), the request identifying the webpage subjects and prompting the LLM to return attributes shared by multiple of the webpage subjects.

15. The method of claim 14, wherein the web browser is further adapted to:
select a subset of attributes returned by the LLM to feature as the task-specific comparative parameters, each attribute in the subset being selected based on similarity to an item referenced within web-based user history data of the user.

16. The method of claim 11, wherein the task-specific comparative parameters are personalized to a user based on previous web interactions and interactions with the decision task assistant of the user or based on stored profile data for the user.

17. The method of claim 15, wherein the task-specific comparative parameters identify at least one of:
an attribute characterizing a subject of a past web interaction of the user; or
a subject referenced within profile data stored by the web browser for the user.

18. 8The method of claim 11, further comprising:
in response to user selection of a sharing icon presented by the web browser in association with the decision task summary, making the decision task summary available for viewing and editing by one or more additional users interacting with a different instance of the web browser.

19. One or more tangible computer-readable storage media encoding computer-executable instructions for executing a computer process, the computer process comprising:
parsing and analyzing web content of multiple browser tabs of a browser session to identify a subset of the multiple browser tabs referencing webpage subjects pertaining to a common decision task;
creating a decision task tab group that includes the subset of the multiple browser tabs;
generating and displaying a decision task summary for the decision task tab group, the decision task summary including:
content summary cards each featuring a summary of content displayed by a different one of the multiple browser tabs of the decision task tab group; and
filter options personalized to at least one of the common decision task or a user of the browser session, each of the filter options referencing a discovered attribute of the webpage subjects referenced by the web content of one of the multiple browser tabs, the filter options each being selectable by a user to hide or unhide a subset of the content summary cards featuring a subset of the webpage subjects characterized by the filter options.

20. The one or more tangible computer-readable storage media of claim 19, wherein generating and displaying the decision task summary further comprises:
transmitting a request to a large language model (LLM), the request identifying the webpage subjects and a request asking the LLM to discover and return attributes of the webpage subjects; and
selecting a subset of attributes returned by the LLM to feature as the filter options, each attribute in the subset being either selected based on similarity to previous web interactions of the user or similarity to stored profile data for the user.
